(19) United States
(12) Patent Application Publication
(10) Pub. No.: US 2025/0052109 A1
(43) Pub. Date: Feb. 13, 2025

(54) AN ARRANGEMENT FOR AT LEAST PARTIALLY COVERING A WINDOW

(71) Applicant: Inter IKEA Systems B.V., Delft (NL)

(72) Inventors: Bo ZHANG, Lund (SE); Alexander VAN DER SPREE, Helsingborg (SE)

(21) Appl. No.: 18/719,919

(22) PCT Filed: Dec. 15, 2022
(86) PCT No.: PCT/SE2022/051180

§ 371 Date: Jun. 14, 2024

(30) Foreign Application Priority Data
Dec. 15, 2021 (SE) 2151532-5

(51) Int. Cl. E06B 9/262; E06B 9/327; E06B 9/388

(52) U.S. Cl. CPC E06B 9/262; E06B 9/327; E06B 9/388; E06B 2009/2627

(57) ABSTRACT

An arrangement for at least partially covering a window. The arrangement includes a covering adapted for being arranged in different intermediate extension states between a retracted state and an extended state for covering the window to different extents. The covering includes a plurality of first sheet element sections which are connected to each other via their edges so that the first sheet element sections form a zigzag shape between opposite ends of the covering in its extension direction, and a plurality of second sheet element sections which are connected to the first sheet element sections so that they project substantially perpendicularly relative to the extension direction of the covering. At least one of the second sheet element sections is connected to every second transition between two adjacent first sheet element sections in the zigzag shape and wherein an edge of the at least one second sheet element section is free.

### TECHNICAL FIELD

The invention relates to an arrangement for at least partially covering a window, wherein the arrangement comprises a covering adapted for being arranged in different intermediate extension states between a retracted state and an extended state for covering the window to different extents. The window may be arranged in a vertical wall, or be formed by a roof light, in a door etc in a building.

Further, the covering may be arranged to substantially cover the complete window in the extended state. Preferably, the covering may be extendable in a continuous way for assuming any intermediate position between the retracted state and the extended state.

Window coverings are used to cover a window to, for example, manage sunlight, to provide insulation, blackout, to ensure privacy or security, to keep insects out or for purely decorative purposes. The window coverings are adapted for being arranged on the interior side of windows. Window coverings may also be referred to as window furnishings, blinds, screens or shades.

Further, coverings of the so-called cellular type, or honeycomb blinds are known. Such a covering comprises a series of tubular cells, which are arranged in parallel with each other, wherein the cells extend in a transverse direction relative to the extension direction of the covering and are open at each end. The cell walls are formed by a fabric. The covering may be designed with a series of single cells or double cells. Further, such a cellular covering may comprise cords that run through the cell structure in the extension direction for moving a lower end of the covering relative to an upper end of the covering so that the cell structure is either compressed or extended for adjusting the covering to different extension states.

In manufacturing of such a cellular blind, each cell is formed by a separate piece of sheet element which is provided with three parallel fold lines with equal spacing. The piece of sheet element is then folded at the fold lines to assume a state where the free ends of the piece of sheet element almost meet. The piece of sheet element may be folded at the fold lines to assume the shape of a parallelogram in cross section. A plurality of such folded pieces of sheet elements are then stacked on top of each other and glued together.

### SUMMARY

A first object of the invention is to achieve a window covering arrangement, which is more efficient in terms of material consumption and creates conditions for an improved manufacturing.

The object is achieved by an arrangement according to claim 1. Thus, it is achieved by an arrangement for at least partially covering a window, wherein the arrangement comprises a covering adapted for being arranged in different intermediate extension states between a retracted state and an extended state for covering the window to different extents, wherein the covering comprises a plurality of first sheet element sections which are connected to each other via their edges so that the first sheet element sections form a zigzag shape between opposite ends of the covering in its extension direction. The covering comprises a plurality of second sheet element sections which are connected to the first sheet element sections so that they project substantially perpendicularly relative to the extension direction of the covering, wherein at least one of the second sheet element sections is connected to every second transition between two adjacent first sheet element sections in the zigzag shape and wherein an edge of the at least one second sheet element section is free. Further, the arrangement comprises an elongated support element, wherein the covering is supported by the elongated support element and movably arranged in a longitudinal direction of the elongated support element between the different extension states in the extension direction. Further, the arrangement comprises at least one covering end piece attached to one of the opposite ends of the covering, wherein the covering end piece comprises a through hole for receipt of the elongated support element in a sliding manner. Further, the covering end piece is adapted to position the covering in the different extension states along the elongated support element via friction.

According to one example, the covering comprises a single zigzag shape via the first sheet element sections. Thus, the covering creates conditions for an open structure, which in turn creates conditions for a reduced material consumption. This is in contrast to the prior art cellular structure, which comprises two spaced and mirrored zigzag shapes forming a closed structure with a series of tubular cells, wherein each cell has the shape of a parallelogram.

In other words, the covering may be designed so that main surfaces of the first sheet element sections on opposite sides of a body defining the first sheet element sections are exposed to the environment. Thus, each one of a first main surface of the first sheet element sections that faces in a first direction, such as inwards with regard to a room, and a second main surface of the first sheet element sections that faces in a second direction, such as outwards (towards a window) with regard to the room, are visible from opposite directions.

The second sheet element sections may be adapted to form a reinforcement of the zigzag shape created by the first sheet element sections. Further, the second sheet element sections may be adapted to support the covering in the movement of the covering in the extension direction.

According to one example, the first sheet element sections provide a non-interrupted surface on a first main side of the covering. The first main side of the covering may be a front side of the covering, which is intended to face an interior of a room. In this way, the second sheet element sections and any support arrangement or other parts present behind the first sheet element sections may be concealed from view from the interior of the room, wherein an aesthetically advantageous design is achieved.

According to one example, the second sheet element sections are arranged on a rear side of the covering, which is intended to face the window. According to one example, all second sheet element sections project in the same direction from the transitions between the first sheet element sections in the zigzag shape. Thus, all second sheet element sections project rearwards from the window covering.

Thus, the covering forms a pleated structure via the sheet element sections. According to one example, the covering comprises a sheet element having a plurality of straight fold lines extending in a transverse direction of the covering and spaced in the extension direction of the covering so that the sheet element can be folded when the ends are displaced towards each other.

According to one example, the first sheet element sections, which are also called pleats, are of equal size and shape. More specifically, the first sheet element sections may have a rectangular shape and be elongated, wherein their longitudinal direction is perpendicular to the extension direction of the covering. Each first sheet element section is defined by two fold lines, i.e. a pleat-delimiting upper fold line and a pleat-delimiting lower fold line.

According to one further example, the second sheet element section are of equal size and shape. More specifically, the second sheet element sections may have a rectangular shape and be elongated, wherein their longitudinal direction is perpendicular to the extension direction of the covering.

According to a further example, the first sheet element sections and the second sheet element sections are of equal size and shape.

Preferably, the covering is extendable in a continuous way for assuming any intermediate position between the retracted state and the extended state. Further, the covering may be adapted for a manual movement to a desired extension state and position with regard to the window.

Further, the covering may be extendable in parallel with a plane. The covering may be designed so that the boundaries of the covering define a rectangular shape in the extended state.

According to one example, each one of the first sheet element sections and the second sheet element sections is planar.

According to one example, the covering is manufactured by joining a plurality of pieces of sheet elements. Each one of such separate pieces of sheet elements may comprise two adjacent first sheet element sections, which are separated via a fold line, and one second sheet element section at either end of the piece of sheet element, wherein each one of the second sheet element sections is connected to its adjacent first sheet element section via a fold line. The piece of sheet element is then folded at the fold lines to assume a state where the first sheet element sections form a V-shape in cross section and the second sheet element sections are in parallel with each other. A plurality of such folded pieces of sheet elements are then stacked on top of each other and glued together via the second sheet element sections.

According to one embodiment example, all the first sheet element sections and all the second sheet element sections of the covering are formed by a single sheet element. The single sheet element may then be provided with a plurality of straight, parallel and spaced fold lines. The fold lines define alternating pairs of first sheet element sections and pairs of second sheet element sections in the extension direction of the sheet element. The sheet element is then folded so that the second sheet element sections in each pair contact each other and are adhered to each other via an adhesive, such as glue. Such a design of a single sheet element creates conditions for a facilitated manufacturing of the covering.

According to one example, the fold lines of the sheet element are arranged with equal spacing in the extension direction of the sheet element before folding.

According to one further embodiment example, the plurality of first sheet element sections comprises a plurality of pairs of adjacent first sheet element sections, which are delimited by a fold line, wherein the adjacent first sheet element sections in each pair are adapted to be arranged in different relative inclination relationships via the fold line for allowing the covering to be arranged in different extension states. In other words, each pair of the first sheet element sections are arranged in a V-shape in cross section, wherein a point of the V is defined by the fold line. More specifically, the two adjacent first sheet element sections in each pair are separated via a straight fold line.

According to one further embodiment example, the plurality of second sheet element sections comprises a plurality of pairs of adjacent second sheet element sections, wherein the adjacent second sheet element sections in each pair are rigidly connected to each other so that they are in the same relative inclination relationship irrespective of the extension state of the covering.

According to one further embodiment example, the adjacent second sheet element sections in each pair are rigidly connected on top of each other so that their extension planes are in parallel with each other. In other words, the pair of second sheet element sections at least partly form a double layer. According to one example, the main surfaces of the adjacent second sheet element sections in each pair, which face each other in the folded configuration, are adhered to each other.

According to a combination of the embodiment examples above, adjacent pairs of first sheet element sections and second sheet element sections are delimited by a fold line. In this way, adjacent first sheet element sections of adjacent pairs of first sheet element sections are connected in the shape of a V, wherein a point of the V is defined by the fold lines. Consequently, the pairs of first sheet element sections are arranged in a continuous row, one after the other in the extension direction of the covering, thereby forming the zigzag shape.

According to one further embodiment example, the first sheet element sections and the second sheet element sections are formed by a fabric.

According to one further embodiment example, the plurality of second sheet element sections comprises at least one set of apertures, which are arranged in-line with each other in the extension direction of the covering, for receipt of an elongated support element. In this way, the second sheet element sections may form a support for the movement of the covering in the extension direction. More specifically, the second sheet element sections may support the covering to extend and retract, respectively, substantially in its extension plane so that it will not bulge during movement. Further, the second sheet element sections may form a support for the covering while in a static state in any state of extension so that it will not bulge.

According to one example, the plurality of second sheet element sections comprises a plurality of parallel and spaced sets of apertures, each set having apertures arranged in-line with each other in the extension direction of the covering. In this way, an operator or end customer may select one of said set of in-line apertures for receipt of the elongated support element.

Further, a piece of sheet element for forming the covering may be produced to a single size (height and width) adapted for windows of different widths, wherein an operator or end customer may cut the piece of sheet element to a desired width matching the window width and use one of the set of in-line apertures in the remaining piece of sheet element.

According to one example, the apertures have a circular shape in cross section and all apertures are of the same dimension.

According to one example, the first sheet element sections are free from any apertures/through holes.

The elongated support element supports the covering to be moved in and be arranged in a desired plane, without bulging. In a typical application of the covering in front of a window in a vertical wall, the elongated support element supports the covering to be moved in and be arranged in a vertical plane.

According to one example, the arrangement comprises at least two elongated support elements, which are arranged in a spaced relationship in a direction perpendicular to the extension direction of the covering.

According to a further development of the last-mentioned embodiment example, the elongated support element is adapted to interact with the covering via the second sheet element sections. According to one example, the elongated support element is adapted to be arranged in one of the set of in-line apertures.

According to a further development of the last-mentioned embodiment example, the elongated support element is at least substantially rigid. In other words, the elongated support element is substantially non-bendable. As an alternative, the elongated support element may be termed a rod. According to one example, the elongated support element may be formed in a metallic material.

This embodiment example creates conditions for an improved child safety in that an elongated at least substantially rigid support element reduces the risk of strangulation in relation to arrangements having cords for the movement of the covering.

According to a further development of the last-mentioned embodiment example, the elongated support element has the same cross section shape and dimension along substantially its complete length. According to one example, the elongated support element has a circular shape in cross section. The elongated support element may have a somewhat smaller cross section in relation to the cross section of the aperture so that the covering may run substantially freely (without friction) along the elongated support element.

According to a further example, the elongated support element may be adapted to assume different lengths for matching window frames of different heights. According to a one example, the elongated support element may be telescopic. According to a further example, the elongated support element may be formed by a plurality of elongated rod parts, which are joined at their ends to form the elongated support element. According to a further example, a first one of the plurality of elongated rod parts comprises a hole extending from an end of the rod part in the longitudinal direction of the rod part and a second one of the rod parts comprises a projection extending in a longitudinal direction of the rod part, which is adapted to be received in the hole. Each one of the hole and projection may have a mating structure, such as a threaded structure, for engagement.

According to one further embodiment example, the arrangement comprises at least one elongated support element end piece rigidly attached to one end of the elongated support element and wherein the at least one elongated support element end piece is adapted to be attached to a wall defining the window so that the elongated support element may be arranged across the window.

According to one example, an elongated support element end piece is rigidly attached to each end of the elongated support element. The elongated support element end piece may be formed by a bracket. The elongated support element end piece may be adapted for being attached to the wall via a fastener, such as a screw, or via an adhesive.

The covering end piece may be arranged so that the through hole is in line with a selected one of the in-line set of apertures. The covering end piece may be formed a rigid body, which may be formed in a plastic material. The covering end piece may form the primary means for allowing the sliding movement of the covering along the elongated support element, wherein the in-line row of apertures in the covering form a secondary means for support in relation to the elongated support element.

According to one example, one covering end piece is attached to each end of the opposite ends of the covering.

According to one further embodiment example, the at least one covering end piece comprises a spring-biased member for contacting an external surface of the elongated support element.

According to one further embodiment example, the arrangement comprises at least one elongated transverse support element, which is adapted to extend in a transverse direction of the covering and comprises an engagement portion for engagement with one of the opposite ends of the covering in its extension direction so that the covering may be moved to different extension states via movement of the transverse support element.

The elongated transverse support element may alternatively be termed cross bar or rail. According to one example, the arrangement comprises two elongated transverse support elements, which are arranged at each one of the opposite ends of the covering in its extension direction. The two elongated transverse support elements may be termed head rail and bottom rail. The elongated transverse support element may be formed a rigid body, which may be formed in a plastic material. According to one example, the at least one elongated transverse support element may comprise a handle portion for manual maneuvering of the covering between the different extension states.

According to one further embodiment example, the at least one covering end piece and the at least one elongated transverse support element comprises complimentary shaped engagement means so that the at least one covering end piece may be rigidly attached to the covering via the at least one elongated transverse support element.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a perspective view of an arrangement for covering a window according to a first embodiment,

FIG. 1A is a perspective view of parts of the arrangement according to a FIG. 1,

FIG. 1B is a cross section view of a covering in the arrangement of FIG. 1A,

FIG. 2A is a partly cut perspective view of an elongated transverse support element for engagement with an end of the covering and an associated handle in an assembly step,

FIG. 2B is a partly cut perspective view of the covering and the elongated transverse support element according to FIG. 2A in a further assembly step,

FIG. 3A is a partly cut perspective view of an end piece for engagement with the elongated transverse support element according to FIG. 2B in a further assembly step,

FIG. 3B is a partly cut perspective view of an elongated rigid support element for engagement with the end piece according to FIG. 3A in a further assembly step,

FIG. 3C is a partly cut perspective view of the elongated rigid support element in engagement with the end piece according to FIG. 3B,

FIG. 4A is a partly cut perspective view of a bracket in engagement with an end of the elongated rigid support element according to FIG. 3C,

FIGS. 4B, 4D and 4E are partly cut perspective views of the bracket according to FIG. 4A in consecutive assembly steps relative to the elongated rigid support element,

FIG. 5 is a partly cut perspective view of the covering supported by the elongated rigid support element in an assembled state,

FIG. 6 is a perspective view of the covering arrangement assembled in a window frame showing that the covering is freely supported,

FIG. 7 is a partly cut perspective view of the covering in consecutive assembly steps according to a first embodiment, and

FIG. 8 is a partly cut perspective view of the covering in consecutive assembly steps according to a second embodiment.

### DETAILED DESCRIPTION OF EXAMPLE EMBODIMENTS

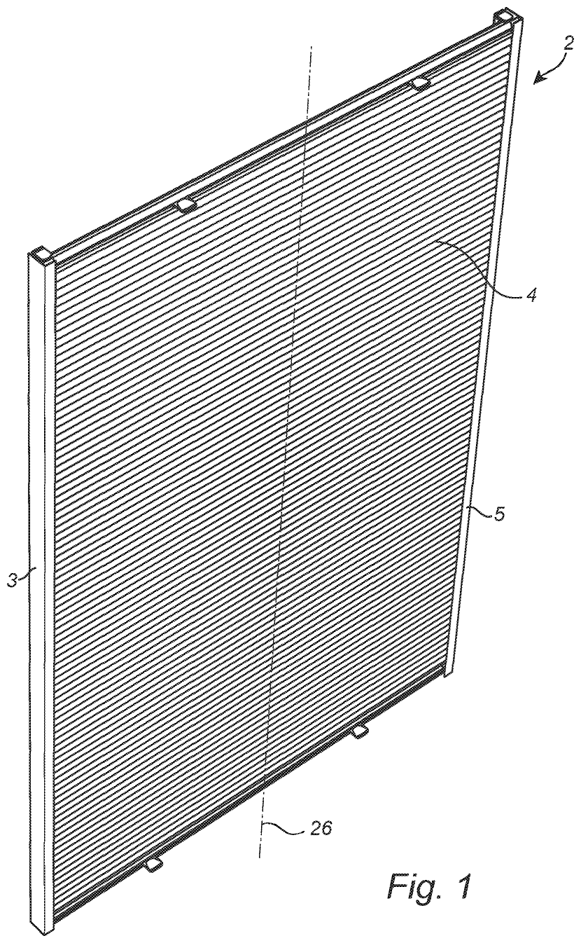

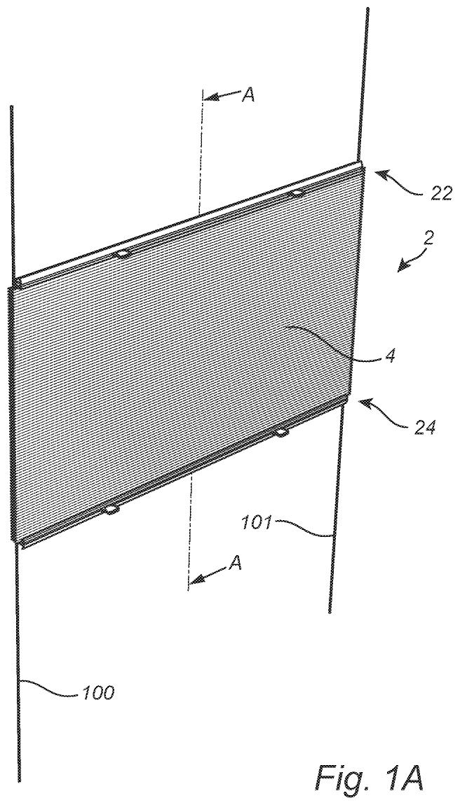

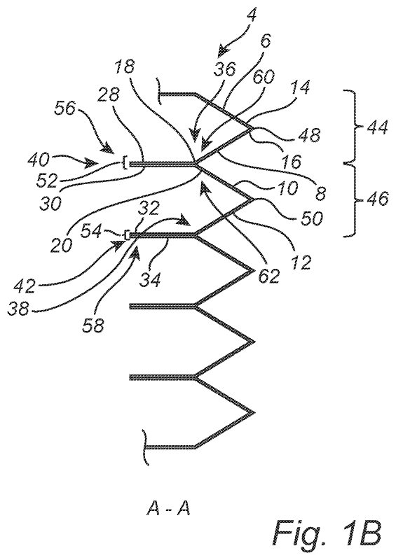

FIG. 1 is a perspective view of an arrangement 2 for covering a window according to a first embodiment. The arrangement 2 comprises a window covering 4 having a pleated structure. The covering 4 is adapted for being arranged in different intermediate extension states between a retracted state and an extended state for covering the window to different extents. In FIG. 1, the covering 4 is arranged in a fully extended state. The arrangement 2 further comprises two elongated and spaced covers 3, 5, which extend in parallel with an extension direction 26 of the covering 4 and are adapted to support and/or conceal opposite ends of the covering 4. The covers 3, 5 may be formed by profiles having an L-shape or U-shape in cross section.

FIG. 1A is a perspective view of the arrangement in FIG. 1, wherein the covers 3, 5 are removed. The arrangement 2 comprises two spaced rigid elongated support elements 100, 101. Each one of the two spaced rigid elongated support elements 100, 101 is straight. Further, the two spaced rigid elongated support elements 100, 101 are arranged in parallel with each other and in parallel with the extension direction 26. Each one of the two spaced rigid elongated support elements 100, 101 is arranged in the vicinity of an end of the covering 4 in a transverse direction of the covering. The covering 4 is supported by the elongated support elements 100, 101 and movably arranged in a longitudinal direction of the elongated support elements 100, 101 between the different extension states in the extension direction 26.

Opposite ends 22, 24 of the covering 4 define an upper boundary and a lower boundary of the covering 4. The upper boundary is non-fixed and slidable in the longitudinal direction of the elongated rigid support elements 100, 101. Likewise, the lower boundary is non-fixed and slidable in the longitudinal direction of the elongated rigid support elements 100, 101. The shading range can thereby be adjusted by adjusting the height of the upper boundary and/or the lower boundary of the covering. Thus, the covering 4 may be said to be freely movable in the extension direction, which allows the user to freely position the shade along the window to achieve a desired shading.

FIG. 1B is a cross section view of the covering 4 in FIG. 1A. The covering 4 comprises a plurality of first sheet element sections 6, 8, 10, 12 which are connected to each other via their edges 14, 16, 18, 20 so that the first sheet element sections 6, 8, 10, 12 form a zigzag shape between the opposite ends 22, 24 of the covering 4 in its extension direction 26.

Further, the covering 4 comprises a plurality of second sheet element sections 28, 30, 32, 34 which are connected to the first sheet element sections 6, 8, 10, 12 so that they project substantially perpendicularly relative to the extension direction 26 of the covering 4, wherein at least one of the second sheet element sections 28, 30, 32, 34 is connected to every second transition 36, 38 between two adjacent first sheet element sections 8, 10 in the zigzag shape and wherein an edge 40, 42 of the at least one second sheet element section 28, 30, 32, 34 is free.

The plurality of first sheet element sections 6, 8, 10, 12 comprises a plurality of pairs 44, 46 of adjacent first sheet element sections, which are delimited by a fold line 48, 50, wherein the adjacent first sheet element sections in each pair are adapted to be arranged in different relative inclination relationships via the fold line 48, 50 for allowing the covering 4 to be arranged in different extension states.

The plurality of second sheet element sections 28, 30, 32, 34 comprises a plurality of pairs 52, 54 of adjacent second sheet element sections, wherein the adjacent second sheet element sections in each pair are rigidly connected to each other so that they are in the same relative inclination relationship irrespective of the extension state of the covering 4.

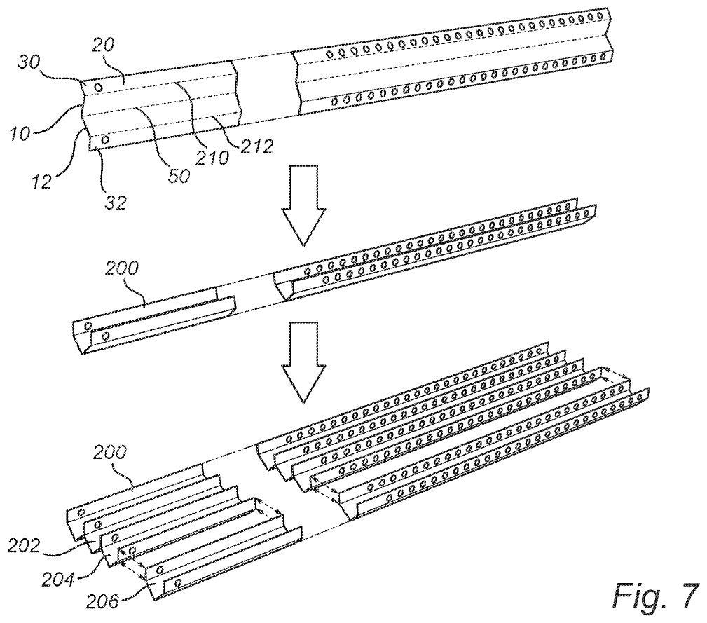

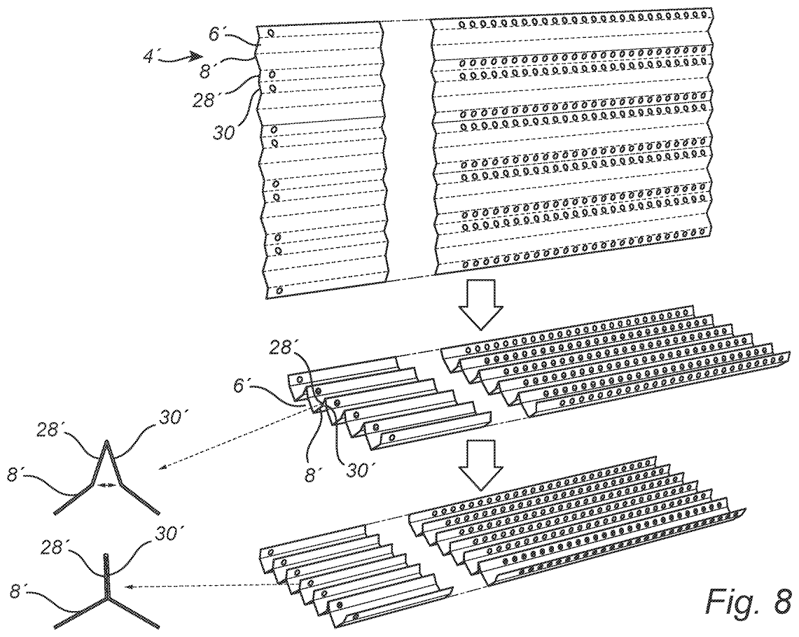

According to one example, the adjacent second sheet element sections 28, 30, 32, 34 in each pair are delimited by a fold line 56, 58, see also FIG. 8. According to an alternative, the adjacent second sheet element sections in each pair are formed by separate parts, which are adhered to each other, wherein there would be no such fold line connecting the adjacent second sheet element sections, see also FIG. 7.

The adjacent second sheet element sections 28, 30, 32, 34 in each pair 52, 54 are rigidly connected on top of each other so that their extension planes are in parallel with each other.

Further, adjacent first sheet element sections 8, 10 in adjacent pairs 44, 46 of first sheet element sections are adapted to be folded relative to one another via fold lines 60, 62 connecting each one of the adjacent first sheet element sections 8, 10 to an adjacent second sheet element section 28, 30. In this way, the first sheet element sections 6, 8, 10, 12 form a uniform zigzag shape between opposite ends 22, 24 of the covering 4, wherein an angle between two first sheet element sections 6, 8, 10, 12 in one of the pairs 44, 46 is substantially the same as an angle between adjacent first sheet element sections 8, 10 in adjacent pairs 44, 46 of first sheet element sections irrespective of the extension state of the covering 4.

The covering 4 comprising the first sheet element sections 6, 8, 10, 12 and the second sheet element sections 28, 30, 32, 34 are formed by a fabric. More specifically, the covering 4 is formed by a woven fabric material.

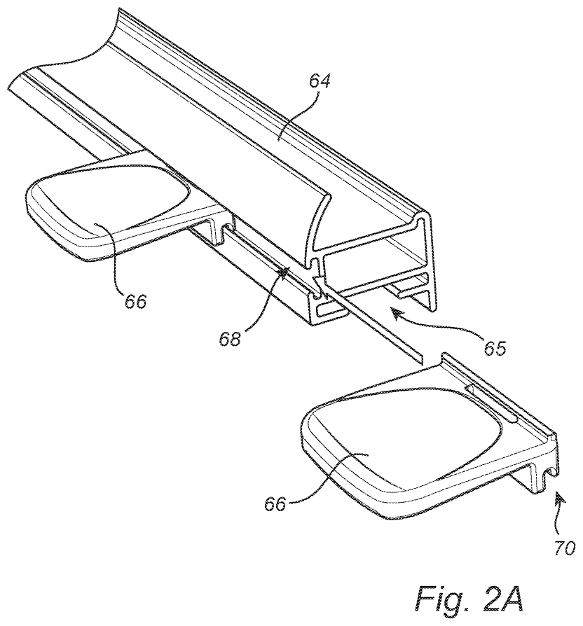

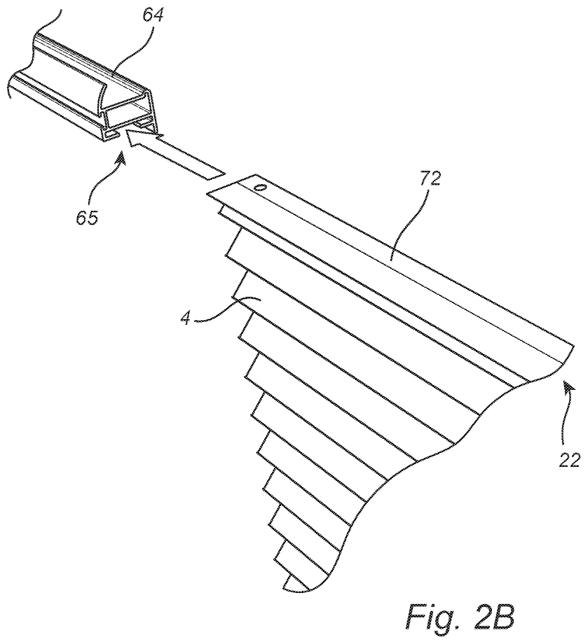

FIG. 2A is a partly cut perspective view of an elongated transverse support element 64, which is adapted to extend in a transverse direction of the covering 4. The elongated transverse support element 64 is adapted for engagement with an end 22 of the covering 4. More specifically, the elongated transverse support element 64 comprises an engagement portion 65 for engagement with the end 22 of the covering 4 in its extension direction, see FIG. 2B, so that the covering may be moved to different extension states via movement of the elongated transverse support element 64.

The elongated transverse support element 64 has a profile, which is constant over its complete length. The elongated transverse support element 64 is rigid and may be formed in a plastic material, such as via extrusion.

The arrangement 2 further comprises a handle 66 for facilitating movement of the covering 4. The elongated transverse support element 64 and the handle 66 comprises engagement portions 68, 70 for engagement in a way that the handle 66 projects transversally relative to a longitudinal direction of the elongated transverse support element 64. More specifically, the engagement portion 68 of the elongated transverse support element 64 comprises an elongated recess extending in the longitudinal direction of the elongated transverse support element 64. The elongated recess is open at the end of the elongated transverse support element 64. The engagement portion 68 of the handle 66 comprises a projection adapted in size and shape for fitting in the elongated recess. The recess and projection may be formed by a dovetail structure. The handle 66 may then be slid from the side into the recess and further to a desired position, see arrow. The handle 66 may be formed in a plastic material.

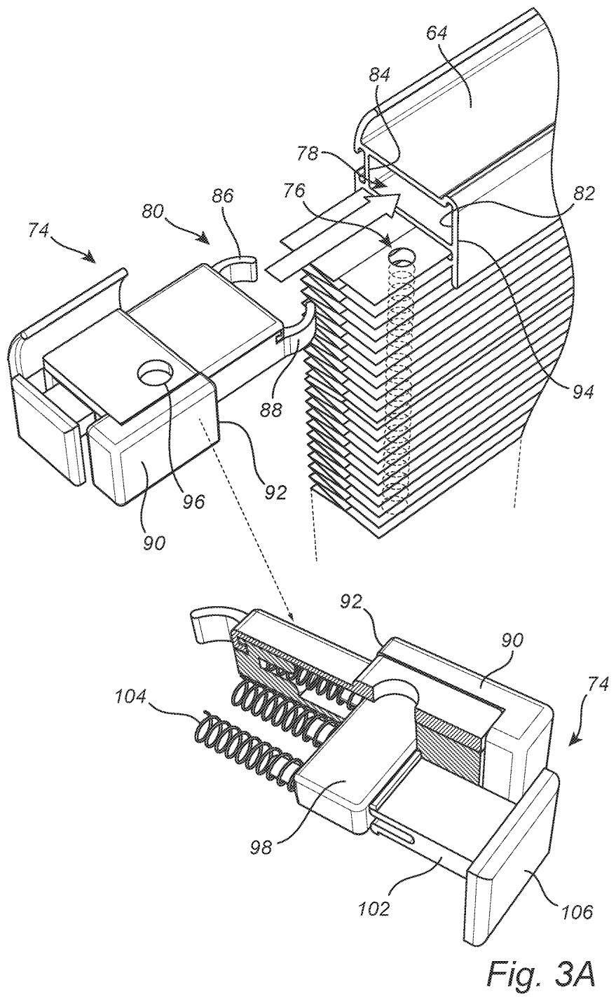

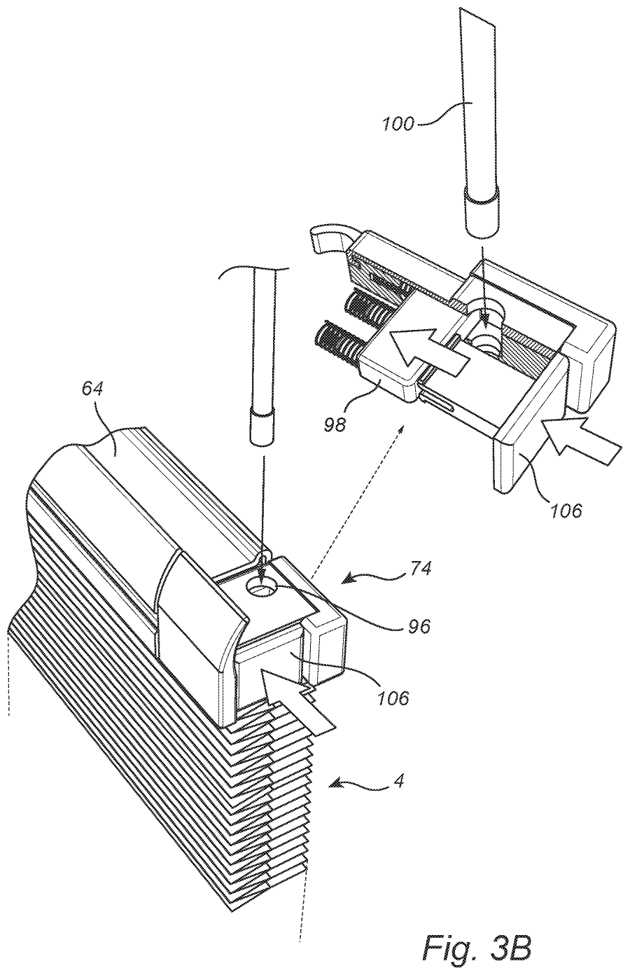

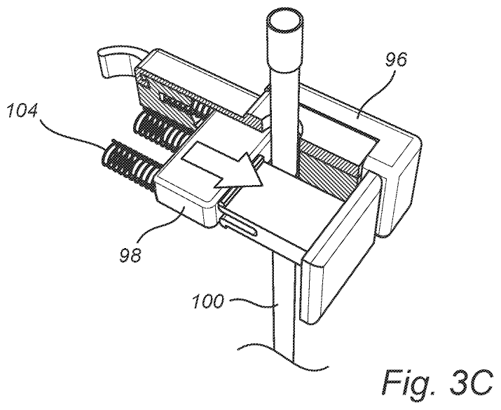

FIG. 2B is a partly cut perspective view of the covering 4 and the elongated transverse support element 64 according to FIG. 2A in a consecutive assembly step. The engagement portion 65 of the elongated transverse support element 64 comprises an elongated recess extending in the longitudinal direction of the elongated transverse support element 64. The elongated recess is open at the end of the elongated transverse support element 64. The recess has a somewhat larger extension in a transverse direction of the elongated transverse support element 64 than an extension of the end 4 of the covering 4 perpendicular to an extension plane of the covering 4 so that the end 22 fits in the recess. More specifically, the end 4 of the covering 4 is formed by a planar sheet-shaped section 72, which may be at least partly formed in plastics. The recess and the planar sheet-shaped section 72 may be formed by a dovetail structure. The covering 4 may then be slid from the side into the recess, see arrow. The covering 4 has a larger extension in its transverse direction than a length of the elongated transverse support element 64 so that the covering 4 projects out of the recess at either end of the elongated transverse support element 64 when the covering 4 is in its operative position relative to the elongated transverse support element 64, see FIG. 3A.

FIG. 3A is a partly cut perspective view of an end piece 74 for engagement with the elongated transverse support element 64 according to FIG. 2B in a further assembly step.

The plurality of second sheet element sections 28, 30, 32, 34 comprises at least one set of apertures 76, which are arranged in-line with each other in the extension direction of the covering 4, for receipt of the rigid elongated support element 100.

The elongated transverse support element 64 comprises a channel 78 having a main extension direction in the longitudinal direction of the elongated transverse support element 64. The channel 78 has a rectangular cross section and is open towards an end of the elongated transverse support element 64.

The at least one covering end piece 74 and the at least one elongated transverse support element 100 comprises complimentary shaped engagement means 80, 82, 84, 86, 88 so that the at least one covering end piece may be attached to the covering via the at least one elongated transverse support element 100.

More specifically, the end piece 74 comprises an engagement portion 80 adapted for engagement with walls 82, 84 defining the channel 76. More specifically, the engagement portion 80 comprises two spaced flexible fingers 86, 88, which have a curved shape and are adapted to contact opposite walls 82, 84 of the channel 76 while being moved towards each other. Further, the end piece 76 comprises a housing 90 with a stop surface 92, which is adapted to contact an end surface 94 of the elongated transverse support element 64. In this way, the end piece 76 may be moved relative to the elongated transverse support element 64 so that the engagement portion 80 is slid into the channel 78 until the stop surface 92 contacts the end surface 94 of the elongated transverse support element 64. The end piece 74 has an extension in the sliding direction commensurate with or somewhat larger than an extension of the portion of the covering 4 projecting out from the elongated transverse support element 64 so that the projecting portion of the covering 4 is covered.

The end piece 74 comprises an opening 96 adapted for being arranged in-line with the set of apertures 76 for receipt of an end of the rigid elongated support element 100, see FIG. 3B. More specifically, the end piece 74 comprises a through hole 96 for receipt of the rigid elongated support element 100 in a sliding manner.

The end piece 74 is adapted to position the covering 4 in the different extension states along the rigid elongated support element 100 via friction. The end piece 74 comprises a spring-biased member 98 arranged inside of the housing 90 for contacting an external surface of the rigid elongated support element 100. The end piece 74 further comprises a spring relief element 102, which is movably arranged relative to the housing 90 and adapted to move the spring-biased member 98 away from the in-line opening 96 and apertures 76 while compressing the spring 104. The spring relief element 102 comprises an operator finger contact surface 106 for manually pushing the spring relief element 102 into the housing 90 so that the spring-biased member 98 is moved away from the in-line opening 96 and apertures 76. Now, in a next assembly step, the rigid elongated support element 100 may be positioned so that its extension direction is in parallel with the in-line opening 96 and apertures 76 and in-line and then moved into the in-line opening 96 and apertures 76, see FIG. 3B.

When the rigid elongated support element 100 has been moved to its operative position in the opening 96 and apertures 76, the operator may release the pressure on the operator finger contact surface 106, wherein the spring-biased member 98 will be moved back towards the rigid elongated support element 100 by means of the spring 104 springing back, see FIG. 3C.

The covering 4 is now assembled in relation to the rigid elongated support element 100. The friction between the spring-biased member 98 and the external surface of the rigid elongated support element 100 will counteract any relative movements between the covering 4 and the elongated support element 100. The spring force of the spring 104 is adapted so that the friction between the spring-biased member 98 and the external surface of the rigid elongated support element 100 may be overcome by an operator operating the handle 66 in a way moving the end of the covering 4 up or down.

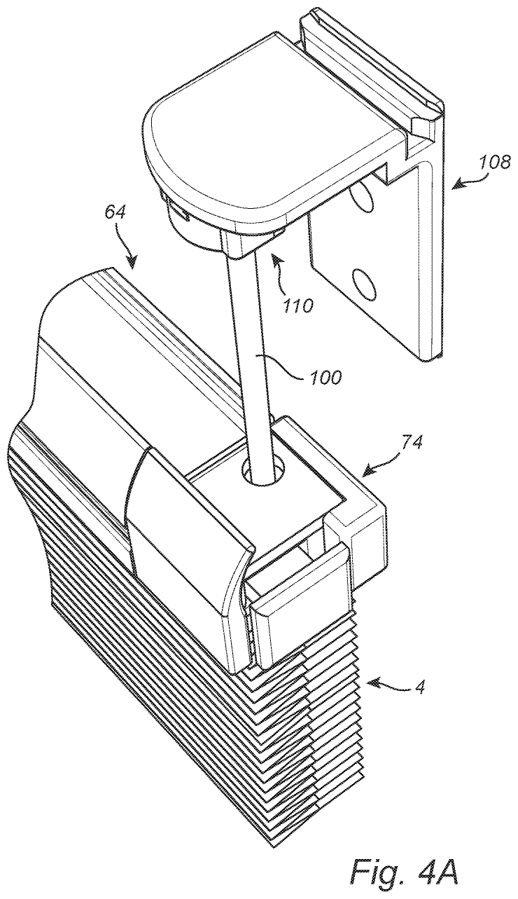

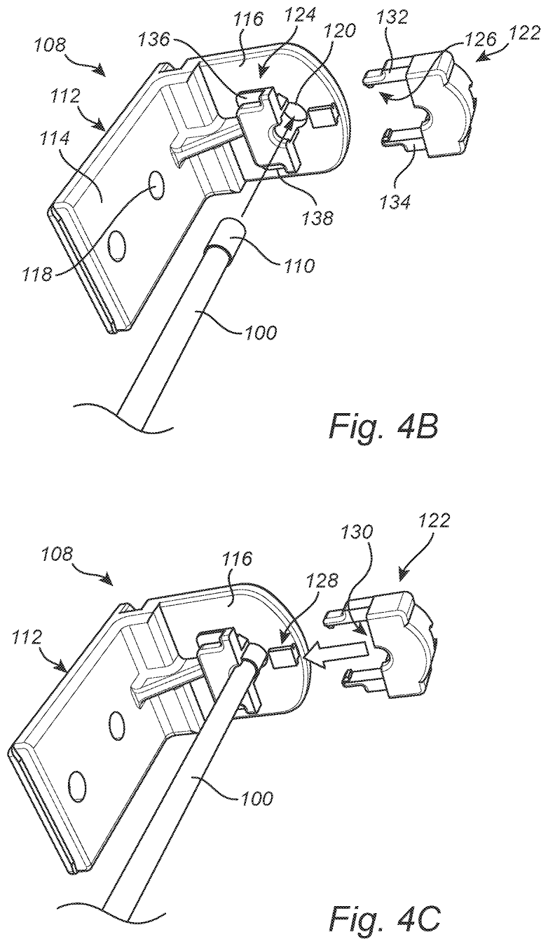

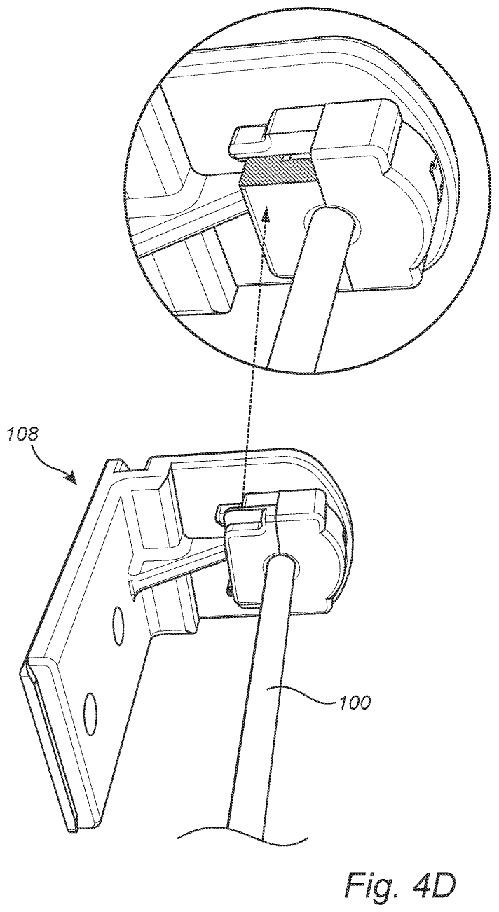

Turning now to FIG. 4A. The arrangement 2 comprises at least one elongated support element end piece 108 rigidly attached to one end 110 of the elongated rigid support element 100. The at least one elongated support element end piece 108 is adapted to be attached to a wall defining the window so that the elongated rigid support element 100 may be arranged across the window. The elongated support element end piece 108 is formed by a bracket and comprises a first element 112, which in turn comprises two generally flat portions 114, 116 arranged perpendicularly relative to one another, see FIG. 4B. A first one of the generally flat portions 114 comprises at least one through hole 118 for receipt of a fastener (not shown) for fastening the bracket to the wall.

A second one of the two generally flat portions 116 comprises a recess 120 for receipt of the end 110 of the elongated rigid support element 100. The end 110 of the elongated rigid support element 100 has a somewhat larger transverse extension than a main body of the elongated rigid support element 100. More specifically, the end 110 of the elongated rigid support element 100 comprises a sleeve arranged around the main body of the elongated rigid support element 100, wherein the sleeve is rigidly attached to the main body.

The elongated support element end piece 108 comprises a second element 122, which is adapted to be engaged to the first element 112. The first element 112 and the second element 122 comprise complimentary shaped engagement portions 124, 126. More specifically, the complimentary shaped engagement portions 124, 126 of the first element 112 and the second element 122 are adapted to be engaged in a way that the elongated rigid support element 100 is clamped between surfaces of the first element 112 and the second element 122.

Further, the second element 122 is adapted to be moved relative to the first element 112 in a direction in parallel with an extension plane of the second generally flat portion 116, see arrow in FIG. 4C, for engagement of the complimentary shaped engagement portions 124, 126. More specifically, the first element 112 and the second element 122 comprise complimentary shaped guide means 128, 130 for guiding the second element 122 to its operative engaged position relative to the first element 112.

More specifically, the engagement portions 126 of the second element 122 is formed by two spaced projections 132, 134, which are flexible towards and away from each other. Similarly, the engagement portions 124 of the first element 112 is formed by two spaced recesses 136, 138, which are adapted so that the flexible projections 132, 134 may enter the recesses. More specifically, the first element 112 comprises a portion adjacent the recesses 136, 138 with a larger transverse extension in relation to a distance between an inner end of the recesses, wherein the flexible projections 132, 134 are arranged so that they will diverge from each other when passing the portion of wider extension and then flex into the recesses.

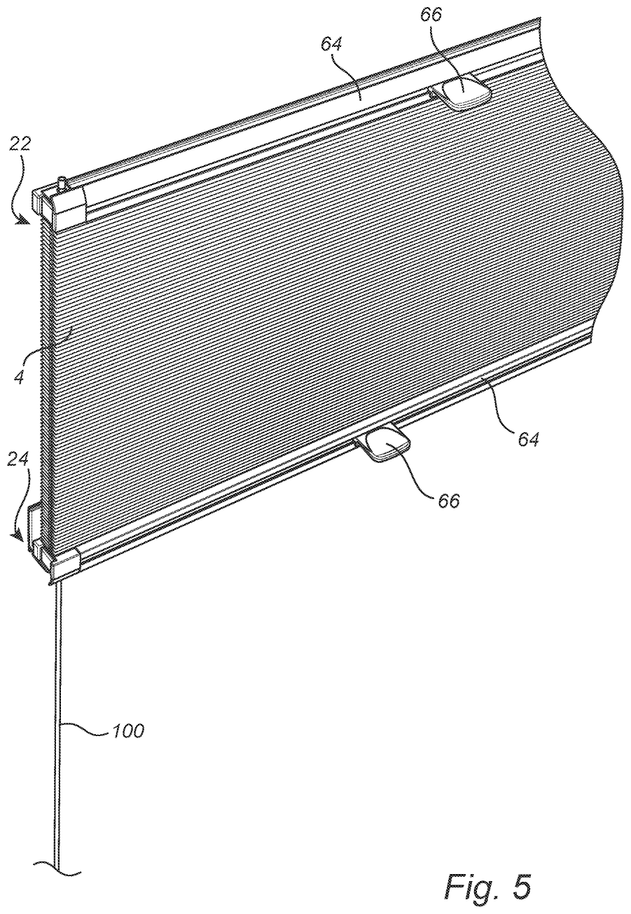

FIG. 5 is a partly cut perspective view of the covering 4 supported by the elongated rigid support element 100 in an assembled state. The covering 4 is provided with elongated transverse support elements 64 attached to each one of the opposite ends 22, 24 of the covering 4.

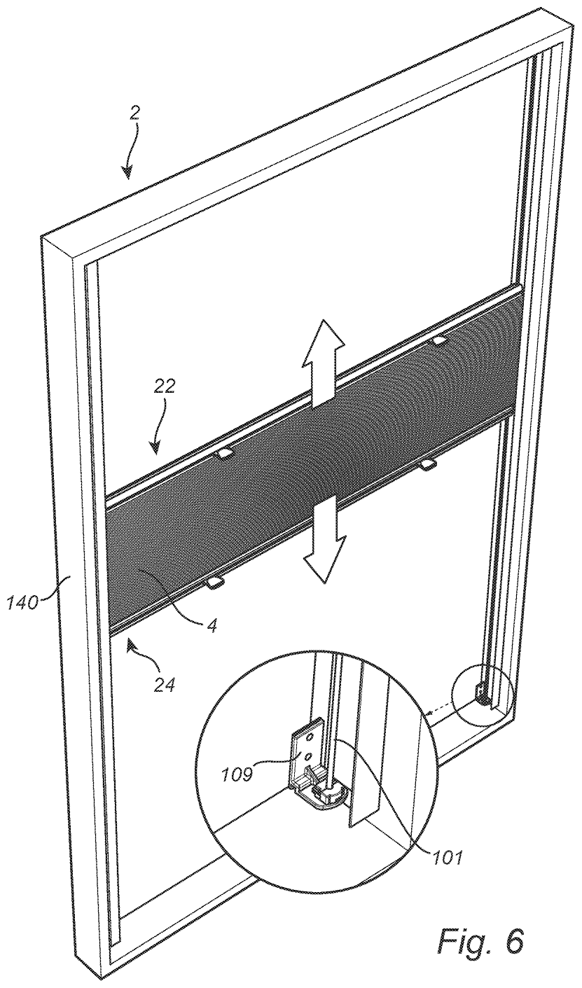

FIG. 6 is a perspective view of the covering arrangement 2 assembled in a window frame 140 showing that the covering 4 is freely supported, wherein either end 22, 24 may be moved towards and away from the other end of the covering 4. FIG. 6 comprises an enlarged view of an end of one of the rigid elongated support elements 101. It is shown that the rigid elongated support elements 101 is attached to the window frame 140 via a bracket 109 similar to the one 108 described above in association with FIG. 4A.

FIG. 7 is a partly cut perspective view of the covering 4 in consecutive assembly steps according to a first embodiment. The covering 4 is formed by a plurality of separate sheets 200, 202, 204, 206. Each one of the sheets 200 comprises one pair of first sheet element sections 10, 12, which are arranged adjacent each other and delimited by a straight fold line 50. Each one of the sheets 200 further comprises one second sheet element section 30 arranged adjacent a first one 10 of the first sheet sections and delimited to the first sheet element section 10 via a straight fold line 210 extending in parallel with the fold line 50. Each one of the sheets 200 further comprises one further second sheet element section 32 arranged adjacent a second one 12 of the first sheet element sections and delimited to the first sheet element section 12 via a straight fold line 212 extending in parallel with the fold line 50. Each one of the sheets 200, 202, 204, 206 are folded via the fold line 50 so that the pair of first sheet element sections 10, 12 are arranged in a V-configuration and via the fold lines 210, 212 so that the second sheet element sections 30, 32 are in parallel with each other. Thus, each one of the sheets 200, 202, 204, 206 will form a separate pleat portion. The plurality of separate sheets 200, 202, 204, 206 are then positioned next to each other so that an external surface of one second sheet element section of one of the sheets faces an external surface of a second sheet element section of an adjacent one of the sheets. Two adjacent sheets 200, 202 may then be joined via application of an adhesive, such as glue, between the external surfaces.

FIG. 8 is a partly cut perspective view of the covering 4′ in consecutive assembly steps according to a second embodiment. The covering 4′ comprises a plurality of first sheet element sections 6′, 8′ and second sheet element sections 28′, 30′, which are delimited by parallel and straight fold lines. The sheet element sections are arranged in a plurality of pairs of first sheet element sections 6′, 8′ and second sheet element sections 28′, 30′, which are arranged in an alternating manner in the extension direction of the covering 4′.

The sheet element is then folded via the fold lines so that adjacent first sheet element sections 10′, 12′ are arranged in a V-configuration and so that adjacent second sheet element sections 28′, 30′ are arranged in parallel with each other and in contact with each other. Adjacent second sheet element sections 28′, 30′ are joined via application of an adhesive, such as glue, between the facing surfaces.

It is to be understood that the present invention is not limited to the embodiments described above and illustrated in the drawings; rather, the skilled person will recognize that many changes and modifications may be made within the scope of the appended claims.

According to the embodiment example described above, either end 22, 24 of the covering 4 may be moved, wherein the covering 4 may be said to be freely movable in the extension direction. According to an alternative, the head rail is mounted to a wall or ceiling of a building. The bottom rail can be lifted or lowered to expand or collapse the pleated shade. According to a further alternative, the bottom rail is fixed while the head rail is moveable to collapse or expand the pleated shade.

According to one alternative, the covering comprises a sheet of material free from pleatings, wherein it may be wound up on a roll, wherein the sheet of material may be extended from the roll by a rotation of the roll. A free end of the sheet of material may then be supported by two spaced elongated rigid support elements via an elongated transverse support element as described above.

According to a further alternative, the covering may be discontinuous, wherein it may have a plurality of separate, interconnected and spaced parallel vane members. The vane members may be arranged to be in parallel with each other in all operative states. The vane members may be arranged to assume different inclined positions in the operative states. The vane members may be interconnected via the elongated rigid support elements and assume a packed condition with decreased internal spacing in the retracted state.

1. An arrangement for at least partially covering a window, wherein the arrangement comprises a covering adapted for being arranged in different intermediate extension states between a retracted state and an extended state for covering the window to different extents, wherein the covering comprises a plurality of first sheet element sections which are connected to each other via their edges so that the first sheet element sections form a zigzag shape between opposite ends of the covering in its extension direction, wherein the covering comprises a plurality of second sheet element sections which are connected to the first sheet element sections so that they project substantially perpendicularly relative to the extension direction of the covering, wherein at least one of the second sheet element sections is connected to every second transition between two adjacent first sheet element sections in the zigzag shape and wherein an edge of the at least one second sheet element section is free, wherein the arrangement comprises an elongated support element, wherein the covering is supported by the elongated support element and movably arranged in a longitudinal direction of the elongated support element between the different extension states in the extension direction characterized in that the arrangement comprises at least one covering end piece attached to one of the opposite ends of the covering, wherein the covering end piece comprises a through hole for receipt of the elongated support element in a sliding manner and that the covering end piece is adapted to position the covering in the different extension states along the elongated support element via friction.

2. The arrangement according to claim 1, wherein all the first sheet element sections and all the second sheet element sections of the covering are formed by a single sheet element.

3. The arrangement according to claim 1, wherein the plurality of first sheet element sections comprises a plurality of pairs of adjacent first sheet element sections, which are delimited by a fold line wherein the adjacent first sheet element sections in each pair are adapted to be arranged in different relative inclination relationships via the fold line for allowing the covering to be arranged in different extension states.

4. The arrangement according to claim 1, wherein the plurality of second sheet element sections comprises a plurality of pairs of adjacent second sheet element sections, wherein the adjacent second sheet element sections in each pair are rigidly connected to each other so that they are in a same relative inclination relationship irrespective of the extension state of the covering.

5. The arrangement according to claim 4, wherein the adjacent second sheet element sections in each pair are rigidly connected on top of each other so that their extension planes are in parallel with each other.

6. The arrangement according to claim 3, wherein the plurality of second sheet element sections comprises a plurality of pairs of adjacent second sheet element sections, wherein the adjacent second sheet element sections in each pair are rigidly connected to each other so that they are in a same relative inclination relationship irrespective of the extension state of the covering, wherein adjacent pairs of first sheet element sections and second sheet element sections are delimited by a fold line.

7. An arrangement according to claim 1, wherein the first sheet element sections and the second sheet element sections are formed by a fabric.

8. The arrangement according to claim 1, wherein the plurality of second sheet element sections comprises at least one set of apertures, which are arranged in-line with each other in the extension direction of the covering, for receipt of an elongated support element.

9. The arrangement according to claim 1, wherein the elongated support element is adapted to interact with the covering via the second sheet element sections.

10. The arrangement according to claim 1, wherein the elongated support element is at least substantially rigid.

11. The arrangement according to claim 1, wherein the arrangement comprises at least one elongated support element end piece rigidly attached to one end of the elongated support element and wherein the at least one elongated support element end piece is adapted to be attached to a wall defining the window so that the elongated support element may be arranged across the window.

12. The arrangement according to claim 1, wherein the at least one covering end piece comprises a spring-biased member for contacting an external surface of the elongated support element.

13. The arrangement according to claim 1, wherein the arrangement comprises at least one elongated transverse support element, which is adapted to extend in a transverse direction of the covering and comprises an engagement portion for engagement with one of the opposite ends of the covering in its extension direction so that the covering may be moved to different extension states via movement of the transverse support element.

14. The arrangement according to claim 13, wherein the at least one covering end piece and the at least one elongated transverse support element comprises complimentary shaped engagement means so that the at least one covering end piece may be attached to the covering via the at least one elongated transverse support element.
